(19) United States
(12) Patent Application Publication
(10) Pub. No.: US 2016/0071452 A1
(43) Pub. Date: Mar. 10, 2016

(54) DEVICES AND METHODS FOR REDUCING OR ELIMINATING MURA ARTIFACT ASSOCIATED WITH WHITE IMAGES

(71) Applicant: APPLE Inc., Cupertino, CA (US)

(72) Inventors: Hyunwoo Nho, Stanford, CA (US); Hopil Bae, Sunnyvale, CA (US); Wei H. Yao, Palo Alto, CA (US)

(21) Appl. No.: 14/794,344

(22) Filed: Jul. 8, 2015

Related U.S. Application Data
(60) Provisional application No. 62/046,623, filed on Sep. 5, 2014.

(51) Int. Cl. G09G 3/20

(52) U.S. Cl. CPC G09G 3/2092; G09G 2320/0257

(57) ABSTRACT

Devices and methods for reducing or eliminating image artifacts are provided. By way of example, a method of preventing an occurrence of an image artifact on a display panel may include generating a first gate signal to be supplied to a first gate of a first transistor, generating a second gate signal to be supplied to a second gate of a second transistor, and adjusting a falling edge rate of the first gate signal or a rising edge rate of the second gate signal to reduce a voltage drop associated with row pixels of the display panel. Adjusting the falling edge rate of the first gate signal or the rising edge rate of the second gate signal include decreasing the falling edge rate of the first gate signal or the rising edge rate of the second gate signal during a period of time in which the first gate signal falls.

### CROSS-REFERENCE TO RELATED APPLICATION

This application is a Non-Provisional patent application of U.S. Provisional Patent Application No. 62/046,623, entitled “Devices and Methods for Reducing or Eliminating Mura Artifacts Associated with White Images,” filed Sep. 5, 2014, which is herein incorporated by reference in its entirety and for all purposes.

### BACKGROUND

The present disclosure relates generally to electronic displays and, more particularly, to electronic displays with reduced or eliminated mura artifacts.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Electronic displays commonly appear in electronic devices such as televisions, computers, and phones. One type of electronic display, known as a liquid crystal display (LCD), displays images by modulating the amount of light allowed to pass through a liquid crystal layer within pixels of the LCD. In general, LCDs modulate the light passing through each pixel by varying a voltage difference between a pixel electrode and a common electrode. This creates an electric field that causes the liquid crystal layer to change alignment. The change in alignment of the liquid crystal layer causes more or less light to pass through the pixel. By changing the voltage difference (often referred to as a data signal) supplied to each pixel, images are produced on the LCD.

In many LCDs, the common electrodes of the pixels of the LCD are all formed from a single common voltage layer (VCOM). Thus, to the extent that undesirable bias voltages or voltage perturbations may occur in the VCOM, any resulting negative effects would be distributed over the entire LCD. When an LCD includes multiple VCOMs, however, it is believed that undesirable bias voltages or voltage perturbations may occur differentially on the various VCOMs. These differential bias voltages or voltage perturbations could produce visible artifacts known as muras, or persistent display screen artifacts and may appear as vertical stripes.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the present disclosure relate to systems, methods, and devices for reducing or eliminating mura artifacts in electronic displays, such as liquid crystal displays (LCDs) or organic light emitting diode (OLED) displays. In a particular example, it is believed that certain artifacts or muras could arise in an LCD having multiple distinct common voltage layers (VCOMs). For example, an LCD with VCOMs generally arranged in alternating rows and columns may exhibit a vertical stripe feature of merit (VSFOM). The VSFOM may appear as alternating light and dark vertical stripes along the LCD. More particularly, these conditions may contribute to gray stripes becoming visible on the LCD when displaying, for example, all-white images (gray-level G255 pixels and/or images) (e.g., text editors, websites with considerable white space, and so forth).

Various embodiments of the present disclosure may reduce and/or substantially eliminate image artifacts (e.g., VSFOM), and, more specifically, image artifacts associated with white images appearing on electronic displays. By way of example, a method of preventing an occurrence of an image artifact on a display panel may include generating a first gate signal to be supplied to a first gate of a first transistor, generating a second gate signal to be supplied to a second gate of a second transistor, and adjusting a falling edge rate of the first gate signal or a rising edge rate of the second gate signal to reduce a voltage drop associated with row pixels of the display panel. Adjusting the falling edge rate of the first gate signal or the rising edge rate of the second gate signal may include decreasing the falling edge rate of the first gate signal or the rising edge rate of the second gate signal during a period of time in which the first gate signal falls and the second gate signal rises to prevent an occurrence of an image artifact on the display panel.

In another example, a method of preventing an occurrence of an image artifact on a display panel may include generating a gate signal to be supplied to a gate of a transistor. The gate signal may include a pulse waveform signal. The method may further include generating a data signal to be supplied to a source of the transistor, and adjusting a magnitude of the data signal to reduce a voltage across the gate and the source of the transistor during a rise time of the gate signal. Adjusting the magnitude of the data signal during the rise time of the gate signal may include substantially preventing an occurrence of an image artifact on the display panel.

In a third example, a display panel useful in reducing and/or substantially eliminating image artifacts (e.g., VSFOM) associated with white images appearing on electronic displays may be provided. By way of example, the display panel may include a pixel, which may include a pixel electrode, a first thin-film transistor (TFT) having a first source coupled to a data line and a first gate coupled to a first gate line, and a second TFT having a second source coupled to a first drain of the first TFT, a second gate coupled to a second gate line, and a second drain coupled to the pixel electrode. The first TFT and the second TFT are configured to pass image data to the pixel electrode. The display panel may also include a gate driver configured to supply a first gate signal to the first gate line and a second gate signal to the second gate line. The second gate signal is modulated between a voltage substantially equal to and a voltage less than that of the first gate signal during a rise period of the first gate signal.

In a fourth example, a display panel may include a pixel. The pixel include a pixel electrode, a first thin-film transistor (TFT) having a first source coupled to a data line, a first gate coupled to a gate line, and a first drain coupled to an electrical connection node. The pixel may also include a second TFT having a second source coupled to the electrical connection node, a second gate coupled to the gate line, and a second drain coupled to the pixel electrode. The first TFT and the second TFT are configured to pass image data to the pixel electrode. The electrical connection node is disposed between the first TFT and the second TFT and configured to reduce a voltage across the second gate and the second source of the second TFT.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic block diagram of an electronic device with a liquid crystal display (LCD) having in-cell touch sensor components, in accordance with an embodiment;

FIG. 2 is a perspective view of a notebook computer representing an embodiment of the electronic device of FIG. 1;

FIG. 3 is a front view of a hand-held device representing another embodiment of the electronic device of FIG. 1;

FIG. 4 is an equivalent circuit diagram of switching a display circuitry of pixels of an LCD and including a source driver, in accordance with an embodiment;

FIG. 5 is a system-level diagram of multiple VCOMs of the LCD, in accordance with an embodiment;

FIG. 6 is an equivalent circuit diagram illustrating positive polarity and negative polarity driven pixels of an LCD and including a source driver, in accordance with an embodiment;

FIG. 7 is a timing diagram illustrating an effect of adjusting a gate signal of the LCD of FIG. 1, in accordance with an embodiment;

FIG. 8 is a component-level circuit diagram of a gate signal generator, in accordance with an embodiment;

FIG. 9 is a timing diagram illustrating an effect of adjusting a gate signal using the gate signal generator of FIG. 8, in accordance with an embodiment;

FIG. 10 is a flowchart illustrating an embodiment of a process suitable for reducing or eliminating mura artifacts (VSFOM) by adjusting a rising edge or falling edge of the gate signal of FIGS. 8 and 9, in accordance with an embodiment;

FIG. 11 is a timing diagram illustrating an effect of modulating a data signal, in accordance with an embodiment;

FIG. 12 is a flowchart illustrating an embodiment of a process suitable for reducing or eliminating mura artifacts (VSFOM) by modulating the data signal of FIG. 11, in accordance with an embodiment;

FIG. 13 is a component-level circuit diagram of a multi-TFT pixel LCD layout, in accordance with an embodiment;

FIG. 14 is a timing diagram illustrating a display scan and a touch scan including a modulated additional gate signal, in accordance with an embodiment;

FIG. 15 is a component-level circuit diagram of an LCD layout including an additional poly material layer, in accordance with an embodiment;

FIG. 16 is a circuit layout diagram of an LCD including the additional poly material layer of FIG. 15, in accordance with an embodiment; and

FIG. 17 is a plot diagram illustrating a gate signal voltage as a function of capacitance and mura artifact (VSFOM) visibility as a function of TFT gate clock rising edge shift, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Embodiments of the present disclosure relate to liquid crystal displays (LCDs) and electronic devices incorporating LCDs that employ touch sensor components within display pixel cells (“in-cell”). Specifically, in-cell touch technology (e.g., in-cell touch charge sensing) may be susceptible to mura artifacts becoming apparent on the LCD. In a particular example, it is believed that certain artifacts or muras could arise in an LCD having multiple distinct common voltage layers (VCOMs). For example, an LCD with VCOMs generally arranged in alternating rows and columns may exhibit a vertical stripe feature of merit (VSFOM). Specifically, during the time the thin-film transistor (TFT) is switched to an “OFF” state, the voltage on the gate of the TFT may begin to fall, and additional charge may be stored on a storage capacitor C_{ST} of the pixel to hold a charge on the pixel electrode of the pixel.

Furthermore, because the VCOM electrodes may exhibit different impedance values, the charge, and by extension, the voltage stored on the liquid crystal (LC) capacitor C_{LC} or storage capacitor C_{ST} may be different for the row and column pixels of the LCD. This difference may create a patterned voltage imbalance between the row pixels and column pixels, and may manifest as undesirable visible artifacts, known as muras or VSFOM, on the LCD. The mura artifacts or VSFOM may be due to differential voltages appearing on distinct segments of common voltage electrodes (VCOMs), and may appear as vertical stripes. Moreover, when applying pixel inversion, column inversion, or line inversion techniques, these conditions may also contribute to darker gray stripes becoming visible on the LCD when displaying a substantially all-white image (e.g., gray level G255 images including photo gallery, text editors, websites including considerable white space, and so forth). Such vertical striping mura artifacts (e.g., VSFOM) may be referred to herein as “white VSFOM.”

Accordingly, various methods and systems of the present disclosure may reduce or substantially eliminate vertical striping mura artifacts (e.g., VSFOM), and, more specifically, vertical striping mura artifacts associated with the displaying of substantially purely white images (e.g., white VSFOM). In one embodiment, first and second gate line voltages may be modulated by adjusting a falling edge rate of the first gate line voltage or adjusting a rising edge rate of the second gate line voltage to reduce a voltage drop associated with row pixels of the display panel when providing a pixel inversion driving method. In a second embodiment, a magnitude of the data signal supplied to one or more TFTs of the display panel may be modulated to reduce a voltage across the gate and the source of the TFTs during a rise time of the gate line voltage supplied to the TFTs. In a third embodiment, the gate line voltage of one of two TFTs coupled to each other within a single pixel in a multi-TFT pixel design (e.g., including multiple independently regulated gate signals) may be modulated. Lastly, in a fourth embodiment, an additional poly material layer (e.g., polycrystalline silicon) (middle node between two TFTs inside a single pixel) may be provided as a buffer to limit in-rush current when the gate of the first TFT of the two TFTs is activated.

As used herein, “row” may refer to at least one axis of an array or matrix of components (e.g., row VCOM electrodes and/or row pixels) on which the components may be substantially aligned. Similarly, “column” may refer to at least one other axis of the array or the matrix of components that may intersect and/or extend in a direction perpendicular to the row axis, and on which other similar components (e.g., column VCOM electrodes and/or column pixels) may be substantially aligned. That is, the “rows” and the “columns” may be respectively understood to refer to any one of at least two axes, in which the two axes are substantially perpendicular. Additionally, the term “mura” may refer to a visual artifact that may remain at least partially visible when the display is on. The nature of mura artifacts may depend on the arrangement of the internal components of the display. For example, when VCOM electrodes are generally arranged in rows and columns as discussed above, the resulting mura artifact(s) may form what may be referred to as a vertical stripe feature of merit (VSFOM), or a manifestation of light and/or dark stripes oriented parallel to, for example, the source lines of the display. Specifically, it should be appreciated that mura artifact and/or VSFOM may manifest as light and/or dark stripes that may appear vertically and/or horizontally with respect to, for example, the viewpoint of a user of the display. Lastly, “white VSFOM” may refer to dark stripes that may appear vertically and/or horizontally with respect to, for example, the viewpoint of a user of the display specifically when all-white or purely white images or portions of images are displayed on the display.

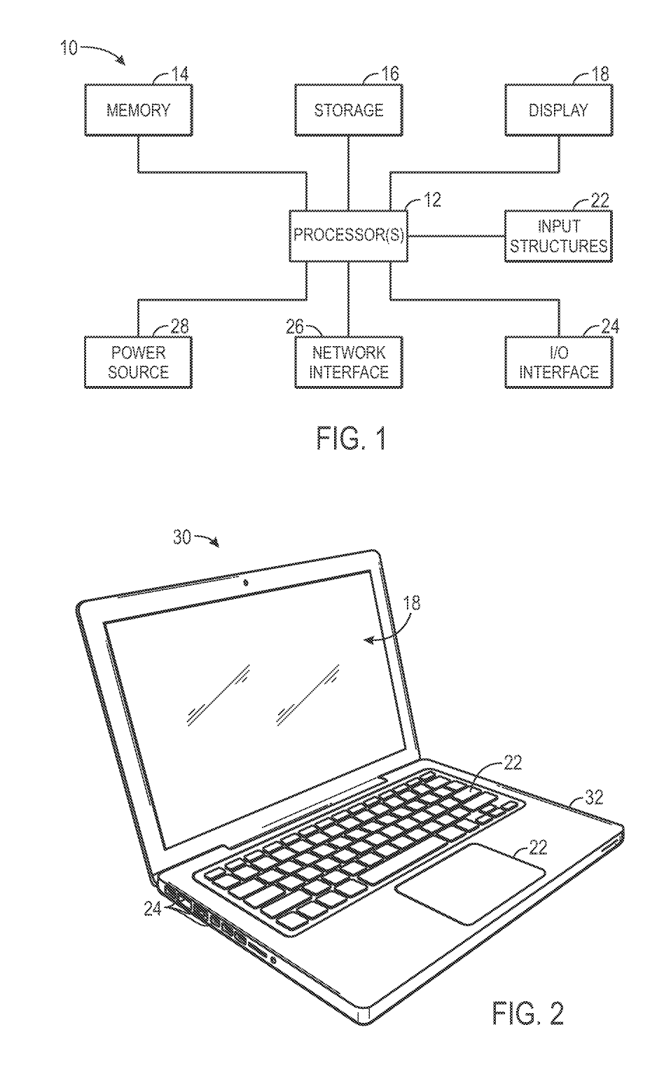

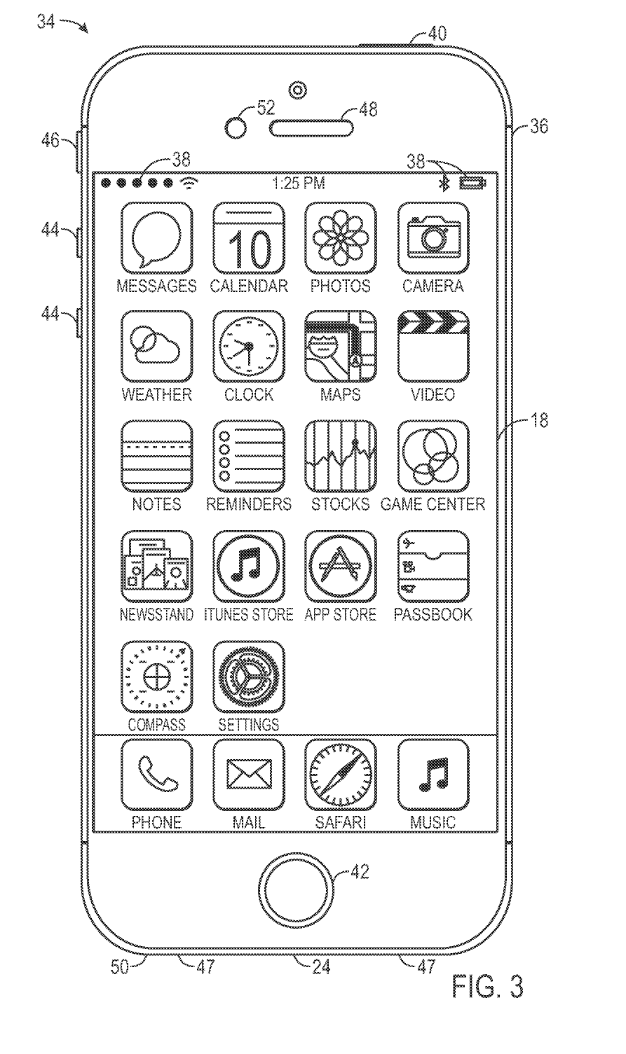

With the foregoing in mind, a general description of suitable electronic devices that may employ electronic touch screen displays having in-cell touch components and are useful in reducing and/or substantially eliminating the mura artifacts that may become apparent on the display will be provided below. In particular, FIG. 1 is a block diagram depicting various components that may be present in an electronic device suitable for use with such a display. FIGS. 2 and 3 respectively illustrate perspective and front views of suitable electronic device, which may be, as illustrated, a notebook computer or a handheld electronic device.

Turning first to FIG. 1, an electronic device 10 according to an embodiment of the present disclosure may include, among other things, one or more processor(s) 12, memory 14, nonvolatile storage 16, a display 18 having in-cell touch sensor components, input structures 22, an input/output (I/O) interface 24, network interfaces 26, and a power source 28. The various functional blocks shown in FIG. 1 may include hardware elements (including circuitry), software elements (including computer code stored on a computer-readable medium) or a combination of both hardware and software elements. It should be noted that FIG. 1 is merely one example of a particular implementation and is intended to illustrate the types of components that may be present in electronic device 10.

By way of example, the electronic device 10 may represent a block diagram of the notebook computer depicted in FIG. 2, the handheld device depicted in FIG. 3, or similar devices. It should be noted that the processor(s) 12 and/or other data processing circuitry may be generally referred to herein as “data processing circuitry.” Such data processing circuitry may be embodied wholly or in part as software, firmware, hardware, or any combination thereof. Furthermore, the data processing circuitry may be a single contained processing module or may be incorporated wholly or partially within any of the other elements within the electronic device 10.

In the electronic device 10 of FIG. 1, the processor(s) 12 and/or other data processing circuitry may be operably coupled with the memory 14 and the nonvolatile memory 16 to perform various algorithms for responding appropriately to a user touch on the display 18. Such programs or instructions executed by the processor(s) 12 may be stored in any suitable article of manufacture that includes one or more tangible, computer-readable media at least collectively storing the instructions or routines, such as the memory 14 and the nonvolatile storage 16. The memory 14 and the nonvolatile storage 16 may include any suitable articles of manufacture for storing data and executable instructions, such as random-access memory, read-only memory, rewritable flash memory, hard drives, and optical discs. Also, programs (e.g., an operating system) encoded on such a computer program product may also include instructions that may be executed by the processor(s) 12 to enable the electronic device 10 to provide various functionalities.

The display 18 may be a touch screen liquid crystal display (LCD), which may allow users to interact with a user interface of the electronic device 10. Various touch sensor components, such as touch sense and/or touch drive electrodes may be located within display pixel cells of the display 18. As mentioned above, in-cell touch sensor components may include integrated display panel components serving a secondary role as touch sensor components. As such, it should be appreciated that the in-cell touch sensor components may be formed from a gate line of the display, a pixel electrode of the display, a common electrode of the display, a data line of the display, or a drain line of the display, or some combination of these elements.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interfaces 26. The network interfaces 26 may include, for example, interfaces for a personal area network (PAN), such as a Bluetooth network, for a local area network (LAN), such as an 802.11x Wi-Fi network, and/or for a wide area network (WAN), such as a 3G or 4G cellular network. The power source 28 of the electronic device 10 may be any suitable source of power, such as a rechargeable lithium polymer (Li-poly) battery and/or an alternating current (AC) power converter.

The electronic device 10 may take the form of a computer or other type of electronic device. Such computers may include computers that are generally portable (such as laptop, notebook, and tablet computers) as well as computers that are generally used in one place (such as conventional desktop computers, workstations and/or servers). In certain embodiments, the electronic device 10 in the form of a computer may be a model of a MacBook®, MacBook® Pro, MacBook Air®, iMac®, Mac® mini, or Mac Pro® available from Apple Inc. By way of example, the electronic device 10, taking the form of a notebook computer 30, is illustrated in FIG. 2 in accordance with one embodiment of the present disclosure. The depicted computer 30 may include a housing 32, a display 18, input structures 22, and ports of an I/O interface 24. In one embodiment, the input structures 22 (such as a keyboard and/or touchpad) may be used to interact with the computer 30, such as to start, control, or operate a GUI or applications running on computer 30. For example, a keyboard and/or touchpad may allow a user to navigate a user interface or application interface displayed on display 18. The display 18 may be relatively thin and/or bright, as the in-cell touch components may not require an additional capacitive touch panel overlaid on it.

FIG. 3 depicts a front view of a handheld device 34, which represents one embodiment of the electronic device 10. The handheld device 34 may represent, for example, a portable phone, a media player, a personal data organizer, a handheld game platform, or any combination of such devices. By way of example, the handheld device 34 may be a model of an iPod® or iPhone® available from Apple Inc. of Cupertino, Calif. In other embodiments, the handheld device 34 may be a tablet-sized embodiment of the electronic device 10, which may be, for example, a model of an iPad® available from Apple Inc.

The handheld device 34 may include an enclosure 36 to protect interior components from physical damage and to shield them from electromagnetic interference. The enclosure 36 may surround the display 18, which may display indicator icons 38. The indicator icons 38 may indicate, among other things, a cellular signal strength, Bluetooth connection, and/or battery life. The I/O interfaces 24 may open through the enclosure 36 and may include, for example, a proprietary I/O port from Apple Inc. to connect to external devices.

User input structures 40, 42, 44, and 46, in combination with the display 18, may allow a user to control the handheld device 34. For example, the input structure 40 may activate or deactivate the handheld device 34, the input structure 42 may navigate user interface to a home screen, a user-configurable application screen, and/or activate a voice-recognition feature of the handheld device 34, the input structures 44 may provide volume control, and the input structure 46 may toggle between vibrate and ring modes. A microphone 48 may obtain a user's voice for various voice-related features, and a speaker 50 may enable audio playback and/or certain phone capabilities. A headphone input 52 may provide a connection to external speakers and/or headphones. As mentioned above, the display 18 may be relatively thin and/or bright, as the in-cell touch components may not require an additional capacitive touch panel overlaid on it.

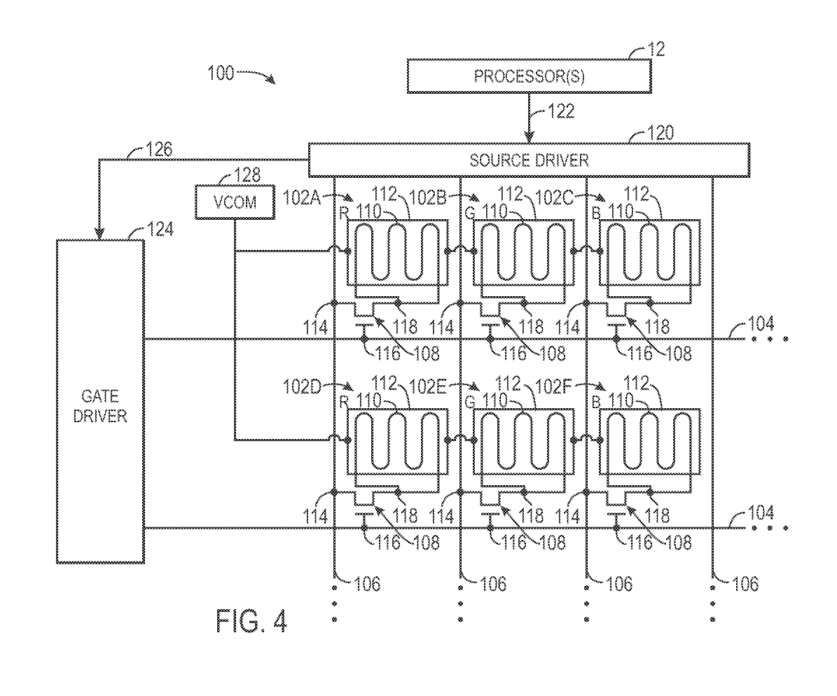

FIG. 4 generally represents a circuit diagram of certain components of the display 18 in accordance with some embodiments. In particular, the pixel array 100 of the display 18 may include a number of unit pixels 102 disposed in a pixel array or matrix. In such an array, each unit pixel 102 may be defined by the intersection of rows and columns, represented by gate lines 104 (also referred to as scanning lines), and data lines 106 (also referred to as data lines), respectively. Although only 6 unit pixels 102, referred to individually by the reference numbers 102a-102f, respectively, are shown for purposes of simplicity, it should be understood that in an actual implementation, each data line 106 and gate line 104 may include hundreds or thousands of such unit pixels 102. Each of the unit pixels 102 may represent one of three subpixels that respectively filters only one color (e.g., red, blue, or green) of light through, for example, a color filter. For purposes of the present disclosure, the terms “pixel,” “subpixel,” and “unit pixel” may be used largely interchangeably.

In the presently illustrated embodiment, each unit pixel 102 may include a thin film transistor (TFT) 108 for switching a data signal stored on a respective pixel electrode 110. The potential stored on the pixel electrode 110 relative to a potential of a common electrode 112 (e.g., creating a liquid crystal capacitance C_{LC}), which may be shared by other pixels 102, may generate an electrical field sufficient to alter the arrangement of liquid crystal molecules (not illustrated in FIG. 4). In the depicted embodiment of FIG. 4, a source 114 of each TFT 108 may be electrically connected to a data line 106 and a gate 116 of each TFT 108 may be electrically connected to a gate line 104. A drain 118 of each TFT 108 may be electrically connected to a respective pixel electrode 110. Each TFT 108 may serve as a switching element that may be activated and deactivated (e.g., turned “ON” and turned “OFF”) for a predetermined period of time based on the respective presence or absence of a scanning signal on the gate lines 104 that are applied to the gates 116 of the TFTs 108.

When activated, a TFT 108 may store the image signals received via the respective data line 106 as a charge upon its corresponding pixel electrode 110. As noted above, the image signals stored by the pixel electrode 110 may be used to generate an electrical field between the respective pixel electrode 110 and a common electrode 112. This electrical field may align the liquid crystal molecules to modulate light transmission through the pixel 102. Furthermore, although not illustrated, it should be appreciated that each unit pixel 102 may also include a storage capacitor C_{ST} that may used to sustain the pixel electrode voltage (e.g., Vₚᵢₓₑₗ) during the time in which the TFTs 108 may be switch to the “OFF” state.

The display 18 also may include a source driver integrated circuit (IC) 120, which may include a chip, such as a processor or application specific integrated circuit (ASIC) that controls the display pixel array 100 by receiving image data 122 from the processor(s) 12, and sending corresponding image signals to the unit pixels 102 of the pixel array 100. The source driver 120 may also provide timing signals 126 to the gate driver 124 to facilitate the activation/deactivation of individual rows of pixels 102. In other embodiments, timing information may be provided to the gate driver 124 in some other manner. The display 18 may or may not include a common voltage (VCOM) source 128 to provide a common voltage (VCOM) voltage to the common electrodes 112. In certain embodiments, the VCOM source 128 may supply a different VCOM to different common electrodes 112 at different times. In other embodiments, the common electrodes 112 all may be maintained at the same potential or similar potential.

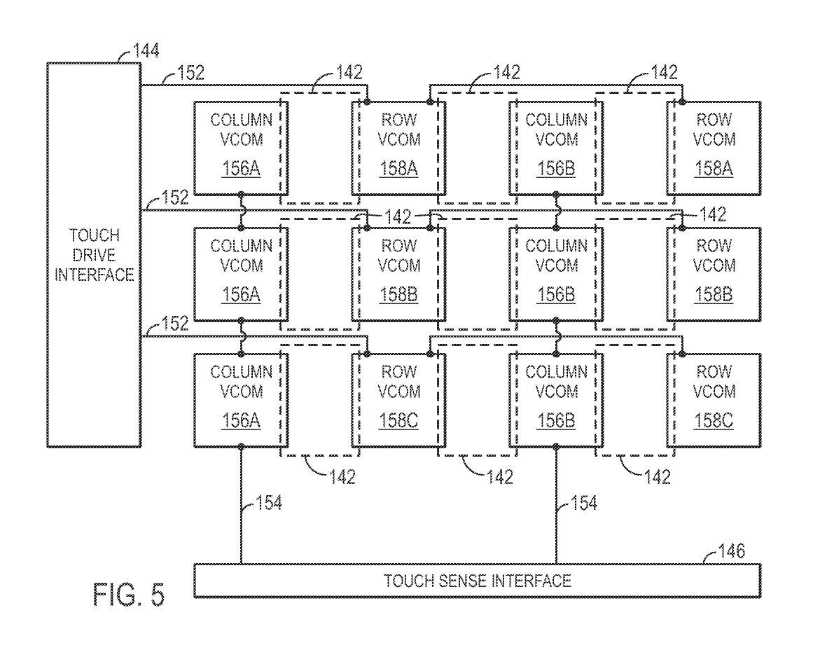

In certain embodiments, as illustrated in FIG. 5, a touch pixel array 140 may include an N×M of touch pixels 142 (e.g., a 6×10 matrix or other size matrix of touch pixels 142). These touch pixels 142 arise due to interactions between touch drive electrodes 152 and touch sense electrodes 154. It should be noted that the terms “lines” and “electrodes” as sometimes used herein simply refers to conductive pathways, and is not intended to be limited to structures that are strictly linear. Rather, the terms “lines” and “electrodes” may encompass pathways that change direction, of different size, shape, materials, and regions. The touch drive electrodes 152 may be driven, for example, by one or more touch drive signals.

The sense lines 154 may respond differently to the touch drive signals when an object, such as a finger, is located near the confluence of a given touch drive electrode 152 and a given touch sense electrode 154. The presence of the object may be “seen” by the touch pixel 142 that may result at an intersection of the touch drive electrode 152 and the touch sense electrode 154. That is, the touch drive electrodes 152 and the touch sense electrodes 154 may form capacitive sensing nodes, or more aptly, the touch pixels 142. It should be appreciated that the respective touch drive electrodes 152 and touch sense electrodes 154 may be formed, for example, from dedicated touch drive electrodes 152 and/or dedicated touch sense electrodes 154, and/or may be formed from one or more gate lines 104 of the display 18, one or more pixel electrodes 110 of the display 18, one or more common electrodes 112 of the display 18, or some combination of these elements.

For example, as further illustrated in FIG. 5, the touch drive electrodes 152 and touch sense electrodes 154 may include column VCOM 156 electrodes and row VCOM 158 electrodes. It should be appreciated that although FIG. 5 depicts only a few column VCOMs 156A and 156B and row VCOMs 158, an actual implementation of the display 18 may include any suitable number of column VCOMs 156 and row VCOMs 158. As previously noted, the column VCOMs 156 and row VCOMs 158 may gather touch sense information when operating in what may be referred to herein as a touch mode of operation. Though the column VCOMs 156 and row VCOMs 158 may be supplied the same direct current (DC) bias voltage, for example, in some embodiments, different alternating current (AC) voltages may be supplied and/or received on VCOMs 156 and 158 at substantially different times. For example, as previously noted, the display 18 may be configured to switch between two modes of operation: a display mode of operation and the touch mode of operation.

In the display mode, the column VCOMs 156 and the row VCOMs 158 may operate in the aforementioned manner, in which an electric field is generated between the column and row VCOMs 156 and 158 and respective pixel electrodes 110. The electric field may modulate the liquid crystal molecules to allow a certain amount of light to pass through the pixel. Thus, an image may be displayed on the display 18 in the display mode. On the other hand, in the touch mode, the row VCOM 158 and the column VCOM 156 may be configured to sense a touch on the display 18. It should also be appreciated that in addition to providing the electric field between the column and row VCOMs 156 and 158 and respective pixel electrodes 110 in the display mode, in some embodiments, this condition may be also provided in the touch mode. In certain embodiments, a stimulus signal or voltage may be provided by the row VCOM 158. The column VCOM 156 may then receive a touch signal and output the data to be processed, for example, by the processor(s) 12. The touch signal may be generated when a user, for example, touches and/or hover a finger nearby the display 18, creating capacitive coupling with a portion of the row VCOM 158 and a portion of the column VCOM 158. Thus, the portion of the column VCOM 156 may receive a signal indicative of the touch and/or hover. In one embodiment, the touch signal (e.g., touch drive signal) may be small enough so as to not interfere with the image displayed on the display 18. As will be further appreciated, due to certain characteristics and/or the arrangement of the column VCOMs 156 and the row VCOMs 158, the display 18 may be susceptible to displaying undesirable vertical striping mura artifacts (e.g., VSFOM).

For example, in certain embodiments, the deactivation (e.g., switching to the “OFF” state) of the respective gates 114 of the TFTs 108 may cause the voltage on the row VCOMs 158 to also exhibit a transient drop due to, for example, capacitive coupling between the gate line 104 and the respective column and row VCOMs 156 and 158. It may then follow that the voltage on the row VCOMs 158, due to the configuration and physical proximity of the row VCOMs 158 to the gate line 104, may experience a longer rise time return to its original voltage value following the deactivation of the respective gates 114.

However, the voltage of the column VCOMs 156 may experience a less significant voltage drop (e.g., due to a difference in impedance between the column VCOMs 156 and the row VCOMs 158) in response to the deactivation of the respective gates 114 of the TFTs 108. As such, the voltage of the column VCOMs 156 may return to its original voltage at a rate faster than that of the row VCOMs 158, thus creating, for example, a voltage imbalance between the row pixels 102 and the column pixels 102 of the display 18. Moreover, because the column VCOM electrodes 156 and row VCOM electrodes 158 may exhibit different resistance values (e.g., R_{CVCOM} and R_{RVCOM}) and/or impedance values, the pixel voltage (e.g., Vₚᵢₓₑₗ) stored on the liquid crystal capacitor C_{LC} may be different for the row and column pixels 102 of the display 18. The imbalance and/or variation in pixel voltage (e.g., Vₚᵢₓₑₗ) between the row pixels 102 and the column pixels 102 of the display 18 may result in different programmed values being stored to the row and column pixels 102 of the display 18, even when the programmed values should be the same. As will be further appreciated, these conditions along with others associated with pixel arrays driven according to a pixel inversion method may contribute to darker gray stripes becoming visible on the display 18 when displaying substantially all-white images (e.g., gray level G255 pixels and/or images) (e.g., photo gallery, text editors, websites including considerable white space, and so forth).

### Gate Line Signal Modulation

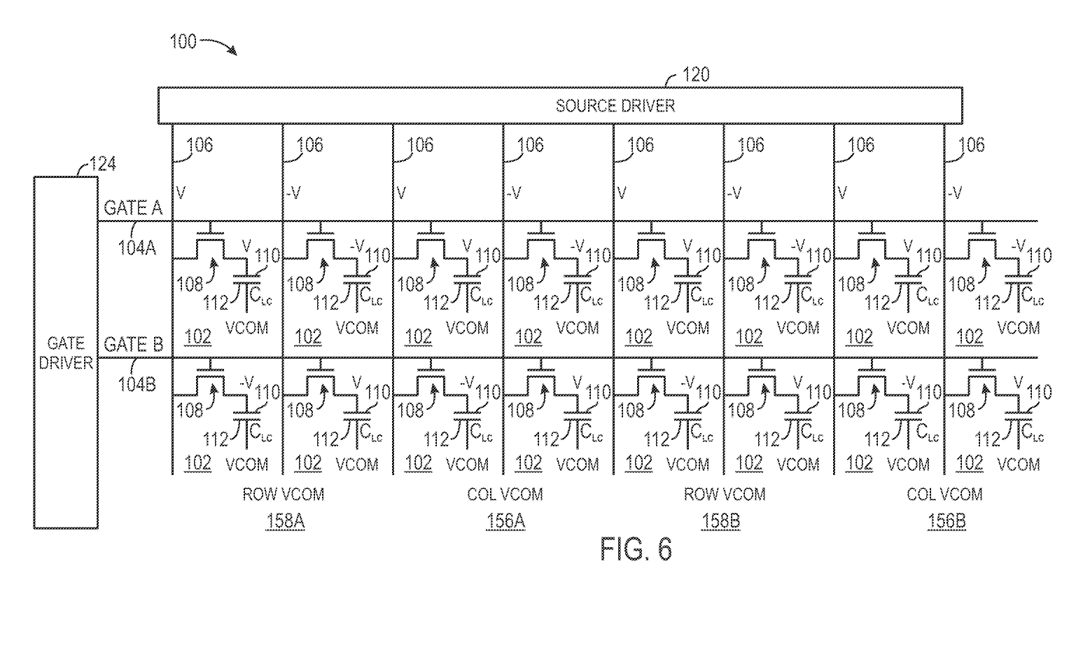

In certain embodiments, as will be discussed below with respect to FIGS. 6-10, adjusting gate signal overlap and/or respective gate signal rise and fall times may reduce or substantially eliminate VSFOM, and, more specifically, VSFOM associated with white images (e.g., gray level G255 images) that may become present on the display 18. Furthermore, as it may be worth noting, the present embodiments of adjusting the gate signal overlap and/or respective gate signal rise and fall times may be performed via the gate driver 124, or in other embodiments, directly via the one or more processor(s) 12.

For example, as illustrated in FIG. 6, the gate driver 124 may drive the unit pixels 102, and, by extension, the TFTs 108 of each of the respective column VCOMs 156 and the row VCOMs 158. As further illustrated in FIG. 6, the unit pixels 102 may be arranged in according to a pixel inversion method, in which, for example, the voltage polarity (e.g., “+V”) of each of the pixels 102 may be inverted with respect to the voltage polarity (e.g., “−V”) of each of the neighboring pixels 102. Specifically, the pixels 102 along the column VCOMs 156 may be inverted with respect to each other pixel 102 in the direction of the column VCOMs 156, and, likewise, the pixels 102 along the row VCOMs 158 may be inverted with respect to each other pixel 102 in the direction of the row VCOMs 158. In one embodiment, for example, the voltage supplied on the gate lines 104 by the gate driver 124 and on the data lines 106 by the source driver 120, respectively, may alternate between approximately −3.3V and +3.3V, between approximately −4V and +4V, between approximately −5V and +5V, between approximately −8V and +8V, between approximately −10V and +10V, or any other suitable range of voltages in accordance with the illustrated pixel inversion arrangement. It should also be appreciated that in addition to, or alternatively to the pixel inversion method as illustrated, the pixels 102 may also be driven according to a line inversion method, a column inversion, or any other suitable voltage polarity inversion technique.

In certain embodiments, as previously discussed, at least partially due to the construction of the pixel array 100 (e.g., the layout of the column and row VCOMs 156 and 158) and the pixel inversion arrangement), darker gray stripes may become visible on the display 18 when displaying a substantially all-white image (e.g., G255 images) (e.g., photo gallery, text editors, websites including considerable white space, and so forth) on the display 18 irrespective of whether or not the display 18 has undergone proper tuning using gray-level images (e.g., G63 images). Specifically, because the pixels 102, and, by extension, the TFTs 108 may be driven according to a pixel inversion method, the deactivation (e.g., switching to the “OFF” state) of the respective gates 114 of the TFTs 108 corresponding to the positive polarity voltage driven pixels 102 (e.g., “GATE A”) and the respective gates 114 of the TFTs 108 corresponding to the positive polarity voltage driven pixels 102 (e.g., “GATE B”) may cause the voltage on the row VCOMs 158 to also exhibit a transient drop due to, for example, capacitive coupling between the gate line 104 and the respective column and row VCOMs 156 and 158.

Specifically, as previously noted, during the time the positive voltage polarity driven TFTs 108 may be switched to an “OFF” state, the voltage on the gates 114 of the positive voltage polarity driven TFTs 108 (e.g., TFTs 108 along the gate line 104A “GATE A”) may begin to fall. Additional charge (e.g., in-rush current) may then flow into the respective LC capacitors C_{LC} coupled to the negative voltage polarity driven TFTs 108 (e.g., TFTs 108 along the gate line 104B “GATE B”) before the voltage on the gate line 104B corresponding to the negative voltage polarity driven TFTs 108 begins to rise. Specifically, the respective voltages on the respective gate lines 104A and 104B may include a difference in timing and may not synchronously overlap.

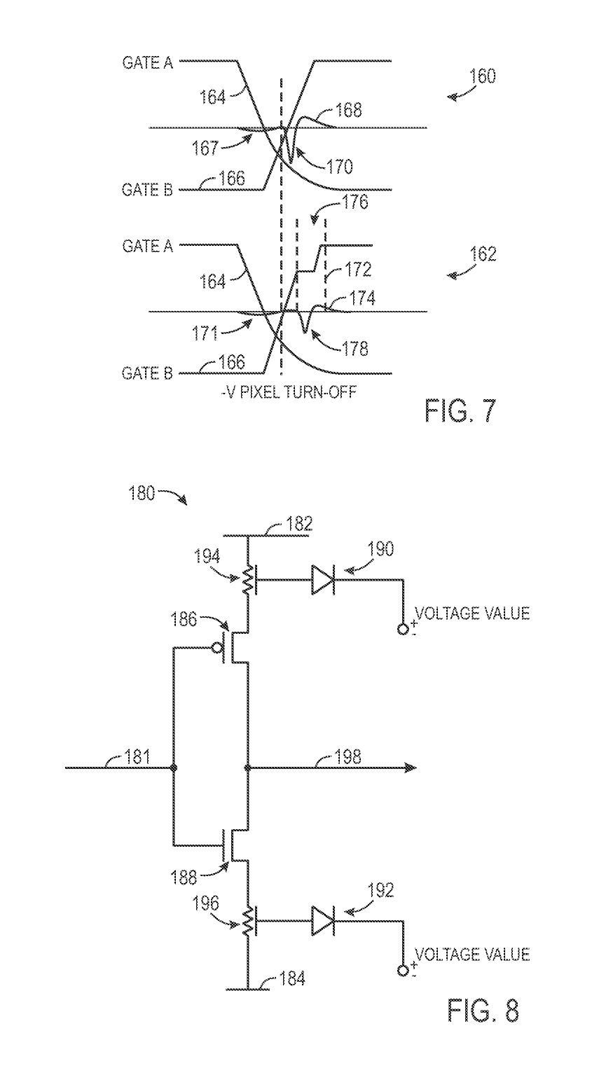

Indeed, as illustrated by the gate voltage plot 160 of FIG. 7, when the gate signal 164 applied to the gates 114 of the positive voltage polarity driven TFTs 108 (e.g., TFTs 108 along the gate line 104A “GATE A”) begins to fall, the voltage on the row VCOMs 158 may experience a first voltage dip 167 (e.g., voltage sag or temporary reduction in voltage). Similarly, as the additional charge (e.g., in-rush current) may flow into the respective LC capacitors (C_{LC}) coupled to the negative polarity driven TFTs 108 (e.g., TFTs 108 along the gate line 104B “GATE B”), a voltage fluctuation 168 may be created on the row VCOMs 158 corresponding to the negative voltage polarity driven TFTs 108. Likewise, as the gate signal 166 applied to the gates 114 of the negative voltage polarity driven TFTs 108 (e.g., TFTs 108 along the gate line 104B “GATE “B”) begins to rise, the voltage on the row VCOMs 158 may experience a more severe second voltage dip 170 (e.g., voltage sag or temporary reduction in voltage) on the row VCOMs 158.

In certain embodiments, this second voltage dip 170 may become apparent on the display 18 as undesirable vertical striping mura artifacts (e.g., VSFOM). Specifically, it should be appreciated that the second voltage dip 170, and, consequentially, the VSFOM (e.g., white VSFOM) that may become apparent on the display 18 may correspond to white images (e.g., pixels 102 with a gray level G255) and/or white portions of an image that are believed to be susceptible to experiencing a much more significant voltage dip 170 as compared to, for example, pixels 102 that may be corresponding to other gray levels (e.g., gray level G63 or other gray levels less than G255).

Thus, in certain embodiments, to reduce or eliminate the occurrence of mura artifacts (e.g., white VSFOM) on the display 18, as further illustrated in FIG. 7, it may be useful to provide techniques of adjusting the gate signal overlap and/or gate signal rise and fall time of the respective positively and negative voltage polarity driven gate signals 164 and 166. For example, as depicted in FIG. 7, a gate voltage plot 162 illustrates that the rise time of the gate signal 166 may be controlled to decrease the voltage dips 167 and 170 on the row VCOMs 158. However, it should be appreciated that, in other embodiments, the fall time of the gate signal 164 may be controlled to decrease the voltage dips 167 and 170 on the row VCOMs 158. As an example, the rise time of the gate line signal 166 may be controlled by delaying the rise time during the rising edge of the gate signal 166 on the gate line 104B (e.g., “GATE B”).

For example, as illustrated, the gate signal 164 (e.g., the voltage on the gate line 104A “GATE A”) may begin to transition to the logically low state (e.g., “OFF” state) at a substantially constant rate. At substantially the same time, the gate signal 166 (e.g., the voltage on the gate line 104B “GATE B”) may start in the logically low state, and subsequently may begin to transition toward the logically high state (e.g., “ON” state). Specifically, as illustrated, the gate signal 166 may initially rise at a substantially constant rate as depicted by the gate signal plot 160. For example, in one embodiment, the gate signal 166 may transition (e.g., rise and fall) between approximately −8V and +8V, or other respective lower (“−V”) and upper (“+V”) voltage rails.

However, as further depicted by the gate signal plot 162, during an interval 174 on the rising edge of the gate signal 166, the gate driver 124 may introduce a delay 176 on the rising edge of the gate signal 166 (e.g., the voltage on the gate line 104B “GATE B”). Specifically, the delay 176 may allow the gate signal 166 (e.g., the voltage on the gate line 104B “GATE B”) to transition (e.g., rise) first, for example, to a median voltage value (e.g., +1V, +2V, +4V, and so forth) between the lower rail voltage (e.g., −3.3V, −4V, −5V, −8V, −10V) and the upper rail voltage (e.g., +3.3V, +4V+8V, +10V), and then to the upper rail voltage following the delay 176. In one embodiment, the delay 176 may include a delay of less than or equal to approximately 10 microseconds (μs), less than or equal to approximately 5 μs, or less than or equal to approximately 1 μs.

In certain embodiments, the median voltage value (e.g., voltage value corresponding to the step in the gate signal 166 of plot 162) may be any voltage value (e.g., any voltage value greater than the common voltage) between the upper and lower transition voltages on the gate line 104B “GATE B.” In this way, by the gate driver 124 providing the gate signal 166 with the delay 176, and, by extension, a decreased rise time, only a minimal voltage dip 178 (e.g., as compared to the voltage dip 170) may be created on the row VCOMs 158. Furthermore, the minimal voltage dip 178 may occur at a later point in time as compared to the voltage dip 170, therefore minimizing, for example, capacitive coupling between the gate line 104A (e.g., “GATE A”) and the respective row VCOMs 158 when the positive voltage polarity driven TFTs 108 deactivate (e.g., switch to the “OFF” state) and/or when the negative voltage polarity driven TFTs 108 activate (e.g., switch to the “ON” state).

In certain embodiments, as illustrated in FIG. 8, a gate signal generator 180 useful in outputting a gate signal (e.g., gate signal 166) having a delayed rise time may be included as part the gate driver 124. As depicted, the gate signal generator 180 may receive an input signal 181 (e.g., timing signal) from, for example, the one or more processor(s) 12. The gate signal generator 180 may include respective upper (e.g., +V_{DD}) and lower (e.g., −V_{DD}) voltage rails 180 and 182. As further depicted, the gate signal generator 180 may also include, in some embodiments, a P-type metal-oxide-semiconductor (PMOS) transistor 186 coupled to an N-type metal-oxide-semiconductor (NMOS) transistor 188. Based on, for example, the polarity of the input signal 181 applied to the gate signal generator 180, and, by extension, to the PMOS transistor 186 and the NMOS transistor 188, the gate signal generator 180 may generate a gate signal output 198.

In certain embodiments, the gate signal generator 180 may also include one or more electrostatic discharge (ESD) diodes 190 and 192 corresponding to the respective lower and upper voltage rails 182 and 184. As depicted, the ESD diodes 192 and 194 may be further coupled to respective resistors 194 and 196. In one embodiment, the ESD diodes 190 and 192 may be shunted diodes, and may be provided as a direct current discharging path useful in controlling the current levels during the rising edge period of the gate signal 166 (e.g., voltage on the gate line 104B “GATE B”) and/or during the falling edge period of the gate signal 164 (e.g., voltage on the gate line 104A “GATE A”) as a technique to decrease the rise time of the gate signal 166 and to ensure that the minimal voltage dip 178 may occur at a later point in time as compared to the voltage dip 170. For example, should the lower voltage rail 184 be set to, for example, −8V, the ESD diodes 190 and 192 may operate to provide a discharge path between only −8V, and, for example, an arbitrary voltage value (VOLTAGE VALUE) (e.g., −4V, −3V, −2V, −1V, +1V, +2V, +3V, +4V) during the rising edge period of the gate signal 166. On the other hand, once the gate signal 166 exceeds the arbitrary voltage value (e.g., voltage value between approximately −8V and +8V), the discharge path provided by way of the ESD diodes 190 and 192 may become temporarily inoperable, and thus slow the rise time (e.g., rise rate) of the gate signal 166.

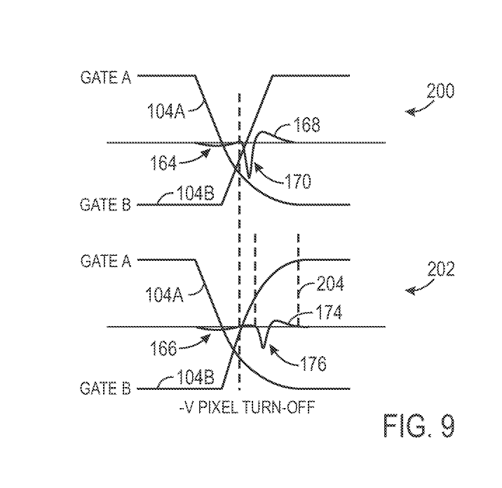

FIG. 9 illustrates a gate signal plot 202 generated by way of the gate signal generator 180 compared with a gate signal plot 200. As depicted in the signal plot 202 of FIG. 9, during an interval 204 on the rising edge of the gate signal 166, the gate signal 166 may initially rise at a constant rate (e.g., corresponding to the time in which the current is discharged by way of the diodes 190 and 192), and subsequently begin to slow (e.g., illustrated by the curvature portion of the gate signal 166 of plot 202) and rise at a decreased rate as compared to the initial constant rate. In this way, the gate signal 166 may be provided with a decreased rise time, and thus only a minimal voltage dip 178 (e.g., as compared to the voltage dip 170) may be created on the row VCOMs 158. Furthermore, as noted above with respect to FIG. 7, the minimal voltage dip 178 may occur at a later point in time as compared to the voltage dip 170 of the gate signal plot 200, therefore minimizing, for example, capacitive coupling between the gate line 104A (e.g., “GATE A”) and the respective row VCOMs 158 when the positive voltage polarity driven TFTs 108 deactivate (e.g., switch to the “OFF” state) and/or when the negative voltage polarity driven TFTs 108 activate (e.g., switch to the “ON” state).

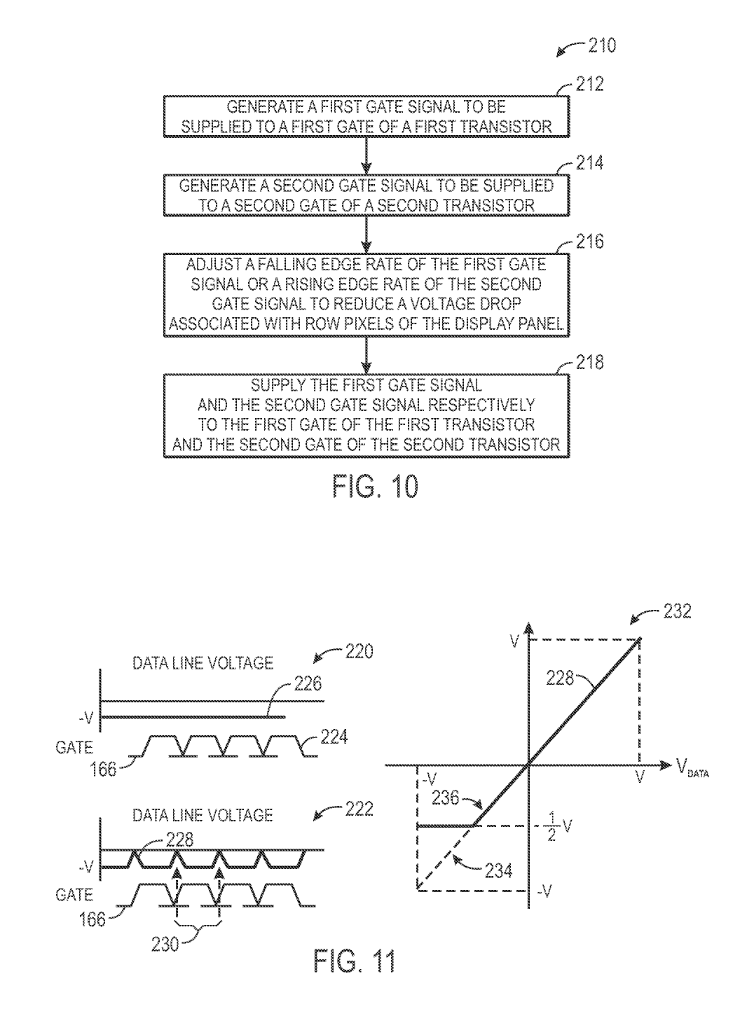

Turning now to FIG. 10, a flow diagram is presented, illustrating an embodiment of a process 210 useful in reducing and/or substantially eliminating artifacts (e.g., VSFOM and/or white VSFOM) on an electronic display by using, for example, the one or more processor(s) 12 or the gate driver 124 as depicted in FIG. 4. The process 210 may include code or instructions stored in a non-transitory machine-readable medium (e.g., the memory 14) and executed, for example, by the one or more processor(s) 12 included within the system 10 or the gate driver 124. The process 210 may begin with the gate driver 124 generating (block 212) a first gate signal to be supplied to a first gate of a first transistor. For example, the gate driver 124 may supply (e.g., via the gate line 104A “GATE A”) the gate signal 164 to the positive voltage polarity driven TFTs 108. The process 210 may then continue with the gate driver 124 generating (block 214) a second gate signal to be supplied to a second gate of a second transistor. For example, the gate driver 124 may supply (e.g., via the gate line 104B “GATE B”) the gate signal 166 to the negative voltage polarity driven TFTs 108.

The process 210 may then continue with the gate driver 124 adjusting (block 216) a falling edge rate of the first gate signal or a rising edge rate of the second gate signal to reduce a voltage drop associated with row pixels of the display panel. For example, as discussed above with respect to FIGS. 7 and 9, the gate driver 124 may generate the gate signal 166 having a delay 176 and/or decreased rise time, thus reducing and delaying the voltage dip 178 of the row VCOMs 158. In this manner, adjusting the gate signal overlap and gate signal rise and/or fall time may reduce or substantially eliminate VSFOM, and, more specifically, VSFOM associated with white images (e.g., gray level G255 pixels and/or images) that may become present on the display 18. The process 210 may then conclude with the gate driver 124 (block 218) supplying the first gate signal (e.g., gate signal 164) and the adjusted second gate signal (e.g., adjusted gate signal 166 including delay 176) respectively to the first gate of the first transistor (e.g., positive voltage polarity driven TFTs 108) and the second gate of the second transistor (negative voltage polarity driven TFTs 108).

### Data Line Signal Modulation

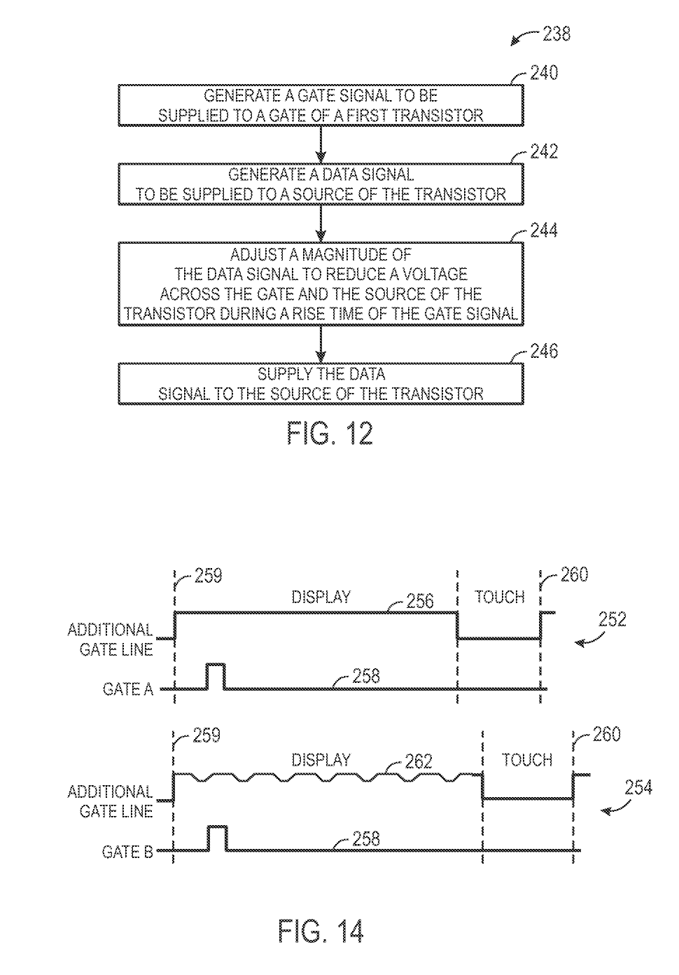

In other embodiments, as illustrated with respect to FIGS. 11 and 12, to reduce or substantially eliminate VSFOM, and, more specifically, VSFOM associated with white images (e.g., gray level G255 pixels or images) that may become present on the display 18, it may be useful to modulate the respective the data signals on the data lines 106. Namely, as it may be appreciated, the voltage across the respective gates 116 and the sources 114 (e.g., gate-to-source voltage V_{GS}), which may, in some embodiments, be referred to as “voltage overdrive,” may be dependent upon the data voltage 226 (e.g., V_{DATA}) and/or the pixel voltage (e.g., V_{PIXEL}) as illustrated by data signal plot 220. Further, the current (e.g., in-rush current or drain-to-source current I_{DS}) flowing into the TFTs 108 on the rising edge of the gate signal 166 may be at least partially dependent on the gate-to-source voltage V_{GS}.

Thus, when the gate signal 166 begins to transition from the negative polarity voltage rail (e.g., −3.3V, −4V, −5V, −8V, −10V) to the positive polarity voltage rail (e.g., +3.3V, +4V+8V, +10V), if the data voltage (e.g., V_{DATA}) is kept at a constant value (e.g., −5V) below or above the common voltage (e.g., V_{COM} or approximately 0V), the current (e.g., drain-to-source current I_{DS}) or charge from the positive polarity driven (e.g., TFTs 108 along the gate line 104A “GATE A”) may flow freely into the negative polarity driven TFTs 108 (e.g., TFTs 108 along the gate line 104B “GATE B”). As discussed above, this may lead to the second voltage dip 176, and, consequentially significant white VSFOM becoming apparent on the display 18.

In certain embodiments, to reduce the magnitude of the gate-to-source voltage V_{GS}, and, by extension, the drain-to-source current I_{DS} and the possible occurrence of white VSFOM, it may be useful to generate (e.g., via the source driver 120) a modulated data signal 228 (e.g., V_{DATA}) as illustrated in the data signal plot 222 of FIG. 11. For example, in certain embodiments, as oppose to a constant value data signal 226 (e.g., −3.3V, −4V, −5V) illustrated in the plot 220, the source driver 120 may modulate the data signal 228 as it is applied to the negative polarity driven TFTs 108 (e.g., TFTs 108 along the gate line 104B “GATE B”). Specifically, the source driver 120 may modulate the data signal 228 (e.g., V_{DATA}) by alternately reducing the magnitude of the data signal 228 between, for example, a predetermined data voltage value (e.g., −3.3V, −4V, −5V) and the common voltage (e.g., V_{COM}) or approximately 0V.

For example, the predetermined data voltage value may be any voltage value less than the common voltage (e.g., V_{COM}) or approximately 0V with respect to gate line signal 166, or any voltage value greater than the common voltage (e.g., V_{COM}) or approximately 0V with respect to gate line signal 164. As further depicted by the plot 222, the modulated data signal 228 may be synchronized with the gate signal 166, such that the modulated data signal 228 may take on a value of the common voltage (e.g., V_{COM}) or approximately 0V at substantially the same point in time 230 the gate signal 166 begins to rise. In this way, the magnitude of the gate-to-source voltage V_{GS}, and, by extension, the drain-to-source current I_{DS} may be mitigated. Thus, modulating the data signal 228 may reduce or substantially eliminate VSFOM, and, more specifically, VSFOM associated with white images (e.g., gray level G255 pixels or images) that may otherwise become apparent on the display 18.

In certain embodiments, in addition to the modulation techniques discussed above, it may be useful to further modulate the data signal 228 as a technique to limit power consumption while performing the discussed data signal modulation techniques. Specifically, as illustrated by the data signal plot 232, the modulated data signal 228 may be further modulated by limiting the alternating data voltage values to, for example, one-half (½) (e.g., −2.5V, −4V) or other fractional value between of the original negative voltage polarity data signal voltage (e.g., −5V, −8V) and the common voltage (e.g., V_{COM}) or approximately 0V. Particularly, instead of allowing the data signal voltage to alternate (e.g., swing) between the negative polarity voltage rail (e.g., −5V, −8V) as illustrated at point 234 and the positive polarity voltage rail (e.g., +5V, +8V), the negative polarity voltage rail of the modulated data signal 228 may be limited to a fraction (e.g., ½) of the negative polarity voltage rail (e.g., −2.5V, −4V) as illustrated at point 236. Thus, in addition to decreasing the magnitude of the gate-to-source voltage V_{GS} and the drain-to-source current I_{DS} as previous discussed, the present embodiments may also be provided to mitigate power consumption of, for example, the system 10 while performing the discussed data signal modulation techniques.

Turning now to FIG. 12, a flow diagram is presented, illustrating an embodiment of a process 238 useful in reducing and/or substantially eliminating mura artifacts (e.g., VSFOM and/or white VSFOM) on an electronic display by using, for example, the one or more processor(s) 12 included within the system 10 depicted in FIG. 1 or the combination of the source driver 120 and the gate driver 124 depicted in FIG. 4. The process 238 may include code or instructions stored in a non-transitory machine-readable medium (e.g., the memory 14) and executed, for example, by the one or more processor(s) 12 included within the system 10 or the combination of the source driver 120 and the gate driver 124. The process 238 may begin with the gate driver 124 generating (block 240) a gate signal (e.g., gate signal 166) to be supplied to a gate of a transistor (e.g., TFT 108). The process 238 may then continue with the source driver 120 generating (block 242) a data signal 226, 228 to be supplied to the source of the transistor (e.g., TFT 108).

The process 238 may then continue with the source driver 120 adjusting (block 244) a magnitude of the data signal 226, 228 to reduce a voltage across the gate and the source of transistor (e.g., TFT 108) during a rise time of the gate signal. For example, as discussed above with respect to FIG. 11, the source driver 120 may modulate the data signal 228 as it is applied to the negative voltage polarity driven TFTs 108 (e.g., TFTs 108 along the gate line 104B “GATE B”) by alternately reducing the magnitude of the data signal 228 between, for example, a predetermined data voltage value (e.g., −3.3V, −4V, −5V) and the common voltage (e.g., V_{COM}) or approximately 0V. The process 238 may then conclude with the source driver 120 (block 246) supplying the data signal (e.g., data signal 228) to the source 114 of the transistor (e.g., TFT 108).

### Gate Line Signal Modulation for Pixels with at Least Two Gate Line Signals

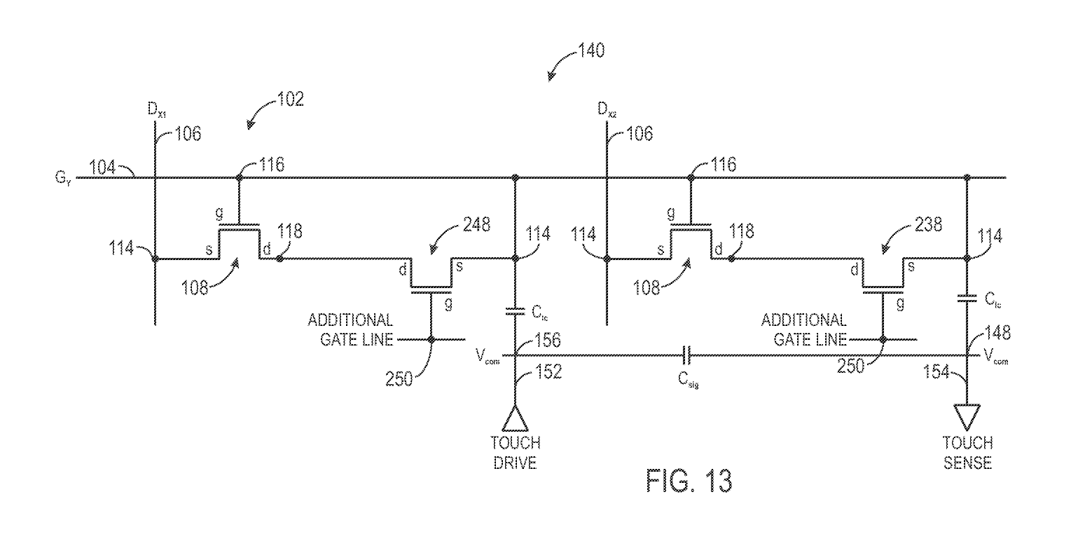

Turning now to FIG. 13, which illustrates an embodiment of a circuit diagram (e.g., equivalent circuit) of one or more display pixels 102 and touch pixels 142 included within, for example, the touch drive regions (e.g., across the row VCOMs 158) and touch sense regions (e.g., along the column VCOMs 158) of the display 18. As depicted, the pixels 102 may include TFTs 108, as previously discussed above with respect to FIGS. 4 and 5. The respective sources 114 of the TFTs 108 may be electrically connected to respective source lines (Dₓ₁) and (Dₓ₂) 106, and the gates 116 of the TFTs 108 may be electrically connected to the gate line (G_{y}) 104. Further, the drains 118 of the TFTs 108 may be electrically connected to respective pixel electrodes 110. As further illustrated, liquid crystal capacitances (C_{LC}) 160 and/or storage capacitances (C_{ST}) 160 may be present between the respective pixel electrodes 110 and the common electrodes 112.

During the display mode of operation, data signals may be supplied to the source lines (Dₓ₁) and (Dₓ₂) 106 and by extension, to the respective sources 114 of the TFTs 108. Similarly, an activation signal may be supplied to the gate line (G_{y}) 104 to activate the gates 116 of the TFTs 108. With the TFTs 108 activated, the data signals supplied to the respective sources 114 flow through the TFTs 108 to the respective drains 118. Thus, the data signal may be supplied to the pixel electrodes 110. Specifically, to store the data signals onto the pixel electrodes 110, the activation signal may be removed from the gate line (G_{y}) 104 while the data signals are still being supplied to the source lines (Dₓ₁) and (Dₓ₂) 106. On the other hand, during the touch mode, touch drive signals 148 generated, for example, by a touch drive amplifier 168 may emanate from the VCOM 156 and generate a touch signal capacitance (C_{SIG}). The touch signal capacitance (C_{SIG}) may be indicative a user touch or hover. The touch signal capacitance (C_{SIG}), or a change thereof (e.g., the indication of the touch or hover), may be then sensed by the VCOM 158 and amplified by a touch sense amplifier.

In certain embodiments, one or more active switches 248 may be included between each of the column VCOMs 156 and the row VCOMs 158 and respective LC capacitances (C_{LC}). Indeed, the one or more active switches 248 may be provided to reduce the dependence of parasitic capacitance (C_{gd}) on the voltage of the pixel electrodes 110, such that any distortion (e.g., image data related distortion) related to the drive signals 148, the sense signals 150, and/or image data signals may be substantially reduced. The active switches 248 may include any active switching devices (e.g., one or more specific transistors, or other solid-state switching devices) useful in shielding the gate lines 104 from parasitic capacitance (C_{gd}). Specifically, during the display mode, for example, an activation signal may be supplied to the gate line (G_{y}) 104 to activate gates 116 of the TFTs 108 (e.g., switch to an “ON” state), which allows image data signals to pass from the sources 114 to the drains 118 of the TFTs 108. At substantially the same time, a gate signal (e.g., which may be distinct from the gate signal supplied to the TFTs 108) may be supplied to an additional gate line 250 to activate the gates of the respective active switches 248 to further regulate the image data signals and reduce the dependence of parasitic capacitance (C_{gd}) on the voltage of the pixel electrodes 110.

In certain embodiments, to reduce or substantially eliminate VSFOM, and, more specifically, VSFOM associated with white images (e.g., gray level G255 pixels or images) that may become present on the display 18, it may be useful to provide techniques to modulate the gate signal (e.g., which may be distinct from the gate signal supplied to the TFTs 108) on the additional gate line 250 during the display and/or touch modes of operation. For example, FIG. 14 illustrates a timing diagrams 252 and 254 that generally show the timing of an additional gate signal 256 and a modulated additional gate signal gate signal 258 during, for example, a display scan period 259 (e.g., a period of time in which image data is stored on the pixel electrodes 110) and a touch scan period 260 (e.g., a period of time in which the display 18 scans for a touch).

In certain embodiments, as depicted by the timing diagram 252, the logically high portion of the additional gate signal 256 (e.g., corresponding to the period the active switching device 248 switches to the “ON” state) may include a substantially constant value throughout the duration of the display scan period 259. As further depicted, the additional gate signal 256 may then fall during the touch scan period 260. In some embodiments, due to, for example, the physical proximity of the additional gate line 250 to the row VCOMs 158 and the synchronization of the additional gate signal 256 with the gate signal 258 supplied to the TFT 108, a substantially constant voltage gate signal 256 may contribute to an occurrence of VSFOM associated with white images (e.g., gray level G255 pixels or images) on the display 18. Thus, in certain embodiments, as depicted by the timing diagram 254, the logically high portion of the additional gate signal 262 (e.g., corresponding to the period the active switching device 248 switches to the “ON” state) may be modulated to reduce voltage coupling between the additional gate line 250 and the row VCOMs 158 and/or between the additional gate line 250 and the gate line 104.

In one embodiment, the additional gate signal 262 may be modulated between, for example, the negative polarity voltage rail (e.g., −5V, −8V, −10V) and a determinate voltage value slightly greater than or slightly less than the respective positive and negative polarity voltage rails. For example, for a negative polarity voltage rail of approximately −8V, the additional gate signal 262 may be modulated between approximately −8V and −6V. In a similar example, for a positive polarity voltage rail of approximately +8V, the additional gate signal 262 may be modulated between approximately +8V and +6V. Furthermore, in certain embodiments, the modulated data signal 228 may be synchronized with the gate signal 258, such that the modulated data signal 262 may be adjusted to the modulated value (e.g., from −8V to −6V, +8V to +6V) at substantially the time the gate signal 258 begins to rise. In this way, voltage coupling between the additional gate line 250 and the row VCOMs 158 and/or between the additional gate line 250 and the gate line 104 may be reduced. Therefore, the present techniques may reduce or substantially eliminate VSFOM, and, more specifically, VSFOM associated with white images (e.g., gray level G255 pixels or images) that may otherwise become apparent on the display 18.

### Gate to Poly-Si Coupling Modulation

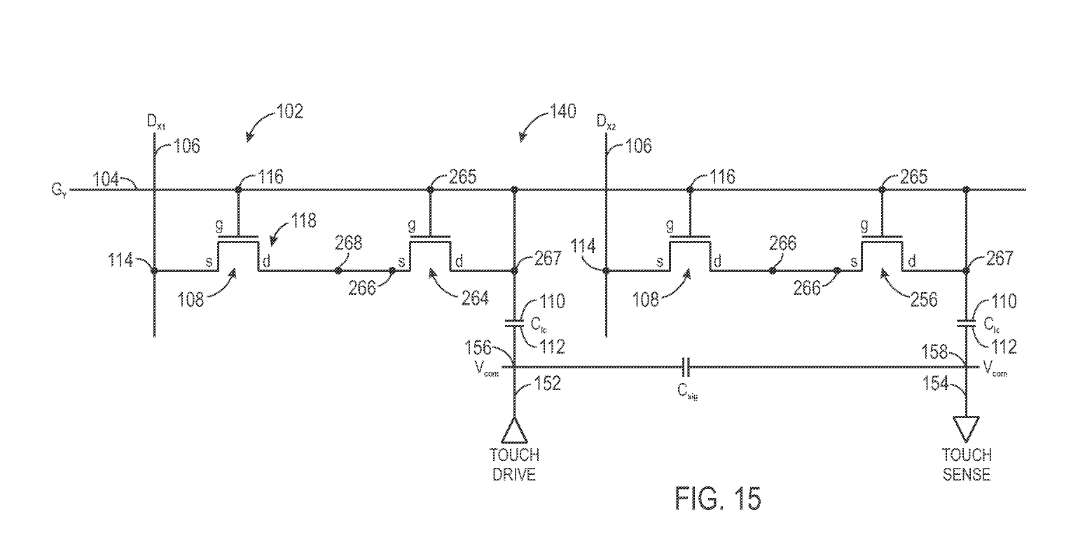

FIG. 15 illustrates an embodiment of a circuit diagram (e.g., equivalent circuit) similar to that discussed with respect to FIG. 13. However, alternatively to the additional gate line 250, FIG. 15 illustrates one or more active switches 264 that may be communicatively coupled to the respective TFTs 108 and driven by the same gate line 104 as illustrated. As similarly discussed above with respect to FIG. 13, the one or more active switches 264, although configured in a different manner, may also be provided to reduce the dependence of parasitic capacitance (C_{gd}) on the voltage of the pixel electrodes 110. The active switches 264 may include any active switching devices (e.g., one or more specific transistors, or other solid-state switching devices) useful in controlling the pixel voltage (e.g., V_{PIXEL}), and by extension, the charge on the pixel electrodes 110. For example, during the display mode, an activation signal may be supplied to the gate line (G_{y}) 104 to activate a gate 265 of the active switch 264 (e.g., switch to an “ON” state), thus allowing the data signals (e.g., V_{DATA}) to pass through the TFTs 108 and active switching devices 264 (e.g., via a source 266 and a drain 267) to the pixel electrodes 110. As previously noted, the respective TFTs 108 and the respective active switching devices may, in some embodiments, be driven by the same gate line 104.

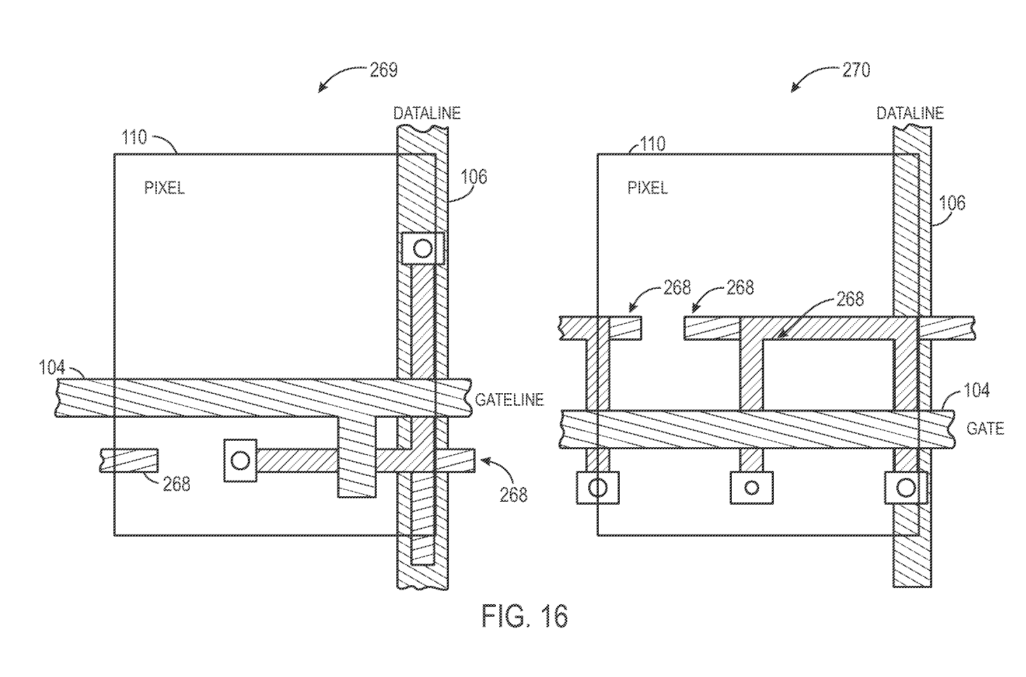

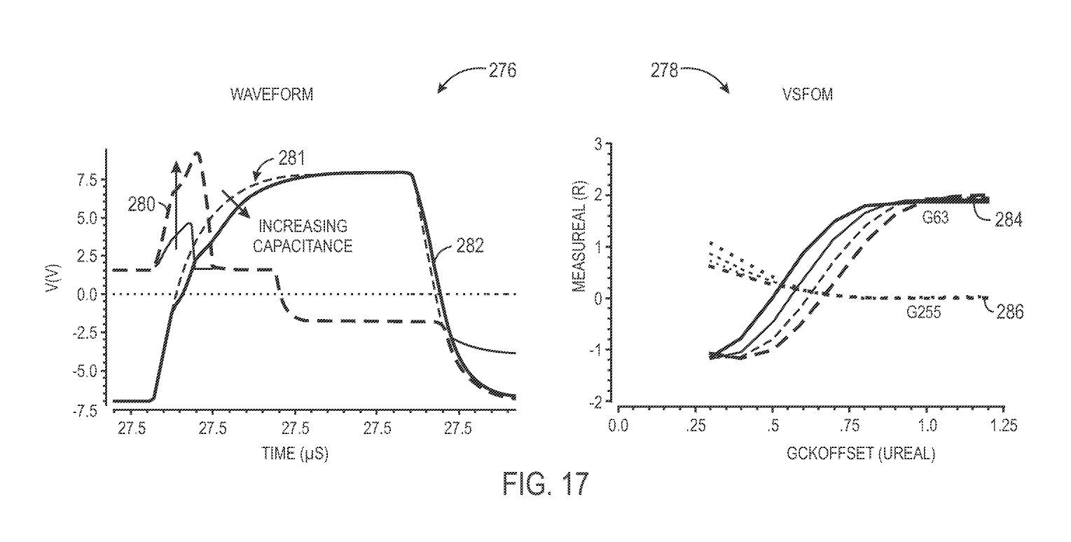

In certain embodiments, as a further technique to mitigate the gate-to-source voltage V_{GS}, and, consequentially, the drain-to-source current I_{DS} (e.g., in-rush current) or other similar charge that may flow into the negative voltage polarity driven TFTs 108 when the negative voltage polarity gate signal (e.g., gate signal 166) begins to rise, and conversely, into the positive voltage polarity driven TFTs 108 when the positive voltage polarity gate signal (e.g., gate signal 164) begins to rise, an additional poly material 268 may be provided as a buffer. In one embodiment, as generally illustrated in the equivalent circuit of FIG. 15, the poly material 268 may act as a node between the respective drains 118 of the TFTs 108 and the respective sources 266 of the active switching devices 264. Specifically, as will be further appreciated with respect to FIG. 16, in certain embodiments, the poly material 268 may include one or more layers of polycrystalline silicon (e.g., polysilicon) that may be provided to mitigate the drain-to-source current I_{DS} (e.g., in-rush current) by causing a capacitive coupling between the respective gates 116 and 265 and the poly material 268.

For example, FIG. 16 illustrates a first layout 269 of a pixel 102 and a second layout 270 of the pixel 102. As depicted in the respective layouts 269 and 270, the poly material 268 may be disposed on, adjacent to, substantially nearby, or about the gate line 104. Specifically, as previously noted with respect to FIG. 15, the poly material 268 may cause a capacitive coupling between the respective gates 116 and 265 of the TFTs 108 and the active switching devices 264, such that when a gate signal (e.g., gate signal 164, 166) rises on the gate line 104, the voltage (e.g., V_{POLY}) of the poly material 268 may also sharply rise.

Such a sharp increase in the voltage (e.g., V_{POLY}) of the poly material 268 may cause an attenuation of the drain-to-source current I_{DS} (e.g., in-rush current) that may have otherwise flowed into the TFTs 108 during the respective positive and negative voltage polarity drive frames. It also follows that the increase in the voltage (e.g., V_{POLY}) of the poly material 268 may also mitigate the gate-to-source voltage V_{GS}, as the poly material 268 may act as a buffer, and may thus at least partially shield the gate-to-source voltage V_{GS} from coupling with the voltage on the gate line 104. Therefore, the present techniques of providing the additional poly material 268 in the construction pixel 102 may reduce or substantially eliminate VSFOM, and, more specifically, VSFOM associated with white images (e.g., gray level G255 pixels or images) that may otherwise become apparent on the display 18.

FIG. 17 depicts a waveform plot 276, which illustrates the impact that an increase in capacitance 280 (e.g., due to the additional poly material 268) has on a gate signal 282 during the rising edge period of the gate signal 282. As depicted, at a point in time 281, the amplitude and/or magnitude of the gate signal 282 may begin to attenuate. As a consequence, the drain-to-source current I_{DS} (e.g., in-rush current) that may have otherwise flowed into the TFTs 108 during the respective positive and negative drive frames may also be mitigated. The resultant reduction in VSFOM (e.g., white VSFOM) is displayed in the corresponding VSFOM plot 278. The plot 278 illustrates VSFOM visibility associated with gray level G63 and gray level G255 pixels and/or images versus rising edge shift of the gate signal 282 as a function of time (e.g., μs). In certain embodiments, the VSFOM visibility (e.g., which may include a dimensionless and/or dimensional value) may be detected and/or measured via a camera or other optical detection device during, for example, the fabrication and/or testing and verification of the display 18. The plot 278 illustrates that by way of the present techniques discussed herein such as, for example, providing the additional poly material 268 in the construction of the pixel 102, the VSFOM visibility associated with both gray level G63 and gray level G255 pixels and/or images may be substantially reduced by the increased capacitance created by way of the additional poly material 268.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A method, comprising:
generating a first gate signal to be supplied to a first gate of a first transistor;
generating a second gate signal to be supplied to a second gate of a second transistor; and
adjusting a falling edge rate of the first gate signal to reduce a voltage drop associated with pixels of a display panel, wherein adjusting the falling edge rate of the first gate signal comprises decreasing the falling edge rate of the first gate signal during a period of time in which the first gate signal falls and the second gate signal rises to prevent an occurrence of an image artifact on the display panel.

2. The method of claim 1, wherein generating the first gate signal to be supplied to the first gate of the first transistor comprises generating a positive polarity gate signal.

3. The method of claim 1, wherein generating the second gate signal to be supplied to the second gate of the second transistor comprises generating a negative polarity gate signal.

4. The method of claim 1, wherein decreasing the falling edge rate of the first gate signal comprises introducing a delay on the falling edge of the first gate signal.

5. The method of claim 4, wherein introducing the delay comprises introducing a delay of less than or equal to approximately 10 microseconds (μs).

6. The method of claim 4, wherein introducing the delay comprises introducing a delay of less than or equal to approximately 5 microseconds (μs).

7. The method of claim 4, wherein introducing the delay comprises introducing a delay of less than or equal to approximately 1 microsecond (μs).

8. The method of claim 1, comprising adjusting a rising edge rate of the second gate signal to reduce the voltage drop associated with the pixels of the display panel.

9. The method of claim 1, comprising supplying the adjusted first gate signal to the first gate of the first transistor and supplying the second gate signal to the second gate of the second transistor.

10. A method, comprising:
generating a first gate signal to be supplied to a first gate of a first transistor;
generating a second gate signal to be supplied to a second gate of a second transistor; and
adjusting a rising edge rate of the second gate signal to reduce a voltage drop associated with pixels of a display panel, wherein adjusting the rising edge rate of the second gate signal comprises decreasing the rising edge rate of the second gate signal during a period of time in which the first gate signal falls and the second gate signal rises to prevent an occurrence of an image artifact on the display panel.

11. The method of claim 10, wherein generating the first gate signal to be supplied to the first gate of the first transistor comprises generating a positive polarity gate signal.

12. The method of claim 10, wherein generating the second gate signal to be supplied to the second gate of the second transistor comprises generating a negative polarity gate signal.

13. The method of claim 10, wherein decreasing the rising edge rate of the second gate signal comprises controlling the second gate signal to rise from a predetermined negative voltage value to an intermediate voltage value for a period time before rising to a predetermined positive voltage value.

14. The method of claim 13, wherein controlling the second gate signal to rise to the intermediate voltage value comprises controlling the second gate signal to rise to a positive voltage value less than the predetermined positive voltage value.

15. The method of claim 10, comprising adjusting a falling edge rate of the first gate signal to reduce the voltage drop associated with the pixels of the display panel.

16. The method of claim 10, comprising supplying the adjusted second gate signal to the second gate of the second transistor and supplying the first gate signal to the first gate of the first transistor.

17. An electronic device, comprising:
gate line driving circuitry, comprising:
a first transistor configured to receive a first signal, wherein the first transistor is configured to activate during a positive cycle of the first signal, and wherein the first transistor is configured to cause the gate line driving circuitry to generate a first gate signal;
a second transistor coupled in series to the first transistor and configured to receive the first signal, wherein the second transistor is configured to activate during a negative cycle of the first signal, and wherein the second transistor is configured to cause the gate line driving circuitry to generate a second gate signal; and
a first diode coupled to the first transistor and a second diode coupled to the second transistor, wherein the first diode and the second diode are configured to provide a current discharge path to control a rate at which the first gate signal falls or the second gate signal rises.

18. The electronic device of claim 17, wherein the first diode and the second diode are configured to control the rate at which the first gate signal falls or the second gate signal rises during a period of time in which the first gate signal falls and the second gate signal rises concurrently.

19. The electronic device of claim 17, wherein first transistor comprises an n-channel metal oxide semiconductor (NMOS) transistor and the second transistor comprises a p-channel metal oxide semiconductor (PMOS) transistor.

20. The electronic device of claim 17, wherein the first diode and the second diode each comprises an electrostatic discharge (ESD) diode.

21. The electronic device of claim 17, wherein the first diode and the second diode are configured to provide the current discharge path during a period in which the second gate signal transitions from a predetermined negative voltage value to an intermediate voltage value, and to not provide the current discharge path during a period in which the second gate signal transitions from the intermediate voltage value to a predetermined positive voltage value.

22. An electronic display, comprising:
a pixel, including:
a pixel electrode;
a first thin-film transistor (TFT) having a first source coupled to a data line and a first gate coupled to a first gate line;
a second TFT having a second source coupled to a first drain of the first TFT, a second gate coupled to a second gate line, and a second drain coupled to the pixel electrode, wherein the first TFT and the second TFT are configured to pass image data to the pixel electrode; and
gate driver circuitry configured to supply a first gate signal to the first gate line and a second gate signal to the second gate line, wherein the gate driver circuitry is configured to modulate the second gate signal between a voltage substantially equal to and a voltage less than that of the first gate signal.

23. The electronic display of claim 22, wherein the gate driver circuitry is configured to modulate the second gate signal between the voltage substantially equal to and the voltage less than that of the first gate signal during a rise period of the first gate signal.

24. The electronic display of claim 22, wherein the gate driver circuitry is configured to modulate the second gate signal to reduce a possible voltage coupling between the first gate line and the second gate line.

25. The electronic display of claim 22, wherein the gate driver circuitry is configured to modulate the second gate signal during a display scan period.

26. The electronic display of claim 22, wherein the gate driver circuitry is configured not to modulate the second gate signal during a touch scan period.

27. A display panel, comprising:
a pixel array comprising a plurality of pixels; and
a gate driver configured to:
provide a first set of activation signals to a first set of the plurality of pixels;
provide a second set of activation signals to a second set of the plurality of pixels; and
adjust a falling edge rate of the first set of activation signals or a rising edge rate of the second set of activation signals to reduce a voltage drop associated with row common voltage electrodes (VCOMs) of the display panel, wherein adjusting the falling edge rate of the first set of activation signals or the rising edge rate of the second set of activation signals comprises delaying the falling edge rate of the first set of activation signals or the rising edge rate of the second set of activation signals during a period of time in which the first set of activation signals falls and the second set of activation signals rises.

28. The display panel of claim 27, wherein the gate driver is configured to delay the falling edge rate of the first set of activation signals or the rising edge rate of the second set of activation signals by approximately 10 microseconds (μs), approximately 5 μs, or approximately 1 μs.

29. The display panel of claim 27, wherein the gate driver is configured to delay the rising edge rate of the second set of activation signals by causing the second set of activation signals to increase from a negative voltage rail to an intermediate voltage for a period time before increasing to a positive voltage rail.

30. The display panel of claim 27, wherein the gate driver is configured to delay the falling edge rate of the first set of activation signals by causing the first set of activation signals to decrease from a positive voltage rail to an intermediate voltage for a period time before decreasing to a negative voltage rail.
